(19) United States
(12) Patent Application Publication
(10) Pub. No.: US 2008/0134454 A1
(43) Pub. Date: Jun. 12, 2008

(54) WIPER BLADE

(76) Inventor: Yang-Gyu Choi, Incheon-city (KR)

Correspondence Address: NOTARO AND MICHALOS, 100 DUTCH HILL ROAD, SUITE 110, ORANGEBURG, NY, 10962-2100, US

(21) Appl. No.: 11/950,091

(22) Filed: Dec. 4, 2007

(30) Foreign Application Priority Data
Dec. 7, 2006 (KR) 10-2006-0125485

(51) Int. Cl. B60S 1/04

(52) U.S. Cl. 15/250.31

(57) ABSTRACT

A wiper blade is provided which more evenly distributes contact pressures on a windshield glass at a central portion and opposite end portions of a rubber element, prevents flotation of the opposite end portions and ensures cleaning quality. The wiper blade comprises a primary lever which a clip is rotatably mounted on and has a predetermined length, the clip being fastened to a connector of a wiper arm of a motor vehicle; a first butterfly spring which is mounted on the lower portion of the primary lever and has a predetermined length; a rubber element which is fastened to the first butterfly spring and contacts at the lower end portion with a windshield glass of the motor vehicle; a second butterfly spring which is mounted above the first butterfly spring at a distance from each other and is supported by the primary lever at the central portion so as to transmit an application force of the wiper arm to opposite end portions of the rubber element; and an end cap which fixes opposite ends of the first and second butterfly springs and opposite ends of the rubber element.

### BACKGROUND OF THE INVENTION

(1) Field of the Invention

The present invention relates in general to a wiper blade which is mounted on a wiper arm of a motor vehicle and which can clean a windshield glass surface more evenly regardless of changes in curvature and inclination of a windshield glass surface.

(2) Description of Related Art

Generally, a wiper blade is mounted on a front windshield glass of a motor vehicle, etc., to perform a function to clean the windshield glass in the motor vehicle.

As illustrated in FIGS. 1 to 3, such a conventional wiper blade generally comprises a rubber element 2 which ordinarily performs a function to directly clean rainwater or foreign substance from a windshield glass 1 in the motor vehicle, a butterfly spring 4 which functions to distribute a force applied by a wiper arm 3 so that the rubber element 2 can effectively contact the windshield glass 1, a spoiler 5 which functions to compensate for flotation of the wiper blade by a wind while the motor vehicle runs, an end cap 6 for fixing the butterfly spring 4 and the rubber element 2 to each other, a connector holder 7 which is fixed to the butterfly spring 4 and also fastened to a connector 3a of the wiper arm 3.

In such a conventional wiper blade as illustrated in FIG. 3, an application force of the wiper arm 3 is concentrated on a central portion under the connector holder 7 and weakens in opposite end portions, thereby causing differences in contact pressures between the central portion and the opposite end portions. In FIG. 3, “p” represents contact pressures.

Thus, a flotation phenomenon occurs in the opposite end portions of the wiper blade on end portion of which wipes the peripheral zone of the windshield glass 1 due to such differences in the contact pressures, and therefore a problem exists in that the windshield glass 1 is not cleaned properly as a whole.

Furthermore, in the conventional wiper blade, elasticity or curvature of the butterfly spring 4 varies so as to effectively contact the rubber element 2 with the windshield glass 1 according to the shape of the windshield glass 1, thereby limiting conditions to be commonly used according to kinds of the motor vehicles, and therefore another problem still exists in that the wiper blade should be inconveniently selected according to the motor vehicle.

Meanwhile, the spoiler 5 of the conventional wiper blade is formed of a streamline shape in order to prevent the flotation of the wiper blade while the motor vehicle runs. But, when the motor vehicle runs at high speed, a water-drawn phenomenon severely occurs that, as illustrated in FIG. 4, water is not blocked, but continuously flows following the returning wiper blade due to air eddies 100 toward a rear side of the wiper blade while the wiper blade is operated toward the lower end after the wiper blade wipes water upwardly and turns in the reverse. Thus, the windshield glass 1 is not cleaned properly and the conventional wiper blade has a disadvantage that it occurs an impediment in a visual range of a driver.

Another prior art wiper blade flotation prevention device is disclosed in Korean Utility Model Laid-open Publication No. KR 20-1998-14736U, wherein a fin which is longer than a first blade arm and higher than the height between the first blade arm and the upper end of the blade is fixed slantingly to the front side of the first blade arm, thereby improving the flotation prevention function and lowering the costs and its weight.

Further another prior art wiper element for cleaning motor vehicle windows is disclosed in Korean Patent Laid-open Publication No. KR 10-2001-34288A, which comprises a wiper blade held by a system of support shackles and which provides for at least one collecting channel oriented in a longitudinal direction to be arranged directly or indirectly on the support shackle system, which channel guides the water outwards from a main field of vision.

Still further another prior art wiper blade is disclosed in Japanese Patent Laid-open Publication No. JP 10-035419A, which is provided with a wiper head used for fixing to a wiper arm, a tilting web, and a wiper lip. The wiper head and the tilting web being made of polychloroprene or a polymer mixture containing not less than 60 percent by weight of polychloroprene and at least one kind of other elastomer, and in the wiper lip, at least a part touching a windshield is made of natural rubber, which is based on diene and provided with hydrocarbon structure, and/or synthetic elastomer, thereby being able to produce a wiper blade in which a combination of advantageous characteristics is provided and a defect in a wiper blade based on a conventional technique is eliminated.

Still further another prior art wiper blade is disclosed in Japanese Patent Laid-open Publication No. JP 14-539015A, which has an extended, rubber elastic wiper strip which can rest on a pane and which is provided with longitudinal open-edged receiving grooves on both of its longitudinal sides, these grooves being located in a plane which is approximately parallel to the pane. A springy elastic mounting rail which is extended in a band-type shape is accommodated in each of the grooves.

However, such prior art wiper blades also have the similar problems mentioned above relating to the conventional wiper blade.

### BRIEF SUMMARY OF THE INVENTION

Accordingly, the present invention is made in order to solve the above problems, and one object of the present invention is to provide a wiper blade which more evenly distributes contact pressures on a wind shield glass by directly transmitting an application force of a wiper arm even on opposite end portions of the wiper blade, and at the same time is designed to prevent flotation of the opposite end portions of the wiper blade.

Further, it is another object of the present invention to provide a wiper blade which can be used in common for various kinds of motor vehicles, ensures cleaning quality, and at the same time, minimizes air eddies occurring in a rear side of the wiper blade while the motor vehicle runs at high speed.

To accomplish the objects of this invention, a wiper blade is provided in accordance with one embodiment of the invention, which comprises a primary lever which a clip is rotatably mounted on and has a predetermined length, the clip being fastened to a connector of a wiper arm of a motor vehicle; a first butterfly spring which is mounted on a lower portion of the primary lever and has a predetermined length; a rubber element which is fastened to the first butterfly spring and contacts at the lower end portion with a windshield glass of the motor vehicle; a second butterfly spring which is mounted above the first butterfly spring at a distance from each other and is supported by the primary lever at the central portion so as to transmit an application force of the wiper arm to opposite end portions of the rubber element; and an end cap which fixes opposite ends of the first and second butterfly springs and opposite ends of the rubber element.

### BRIEF DESCRIPTION OF THE SEVERAL VIEWS OF THE DRAWINGS

The invention will now be described by way of non-limitative example with reference to the following drawings.

FIG. 1 illustrates a front view of a conventional wiper blade.

FIG. 2 illustrates a schematically cross-sectional view along section line A-A shown in FIG. 1.

FIG. 3 illustrates a contact pressure distribution diagram in the wiper blade of FIG. 1.

FIG. 4 illustrates a schematically cross-sectional view along section line A-A of FIG. 1 for further showing air flow surrounding the wiper blade while a motor vehicle runs at high speed.

FIG. 5 shows a perspective view of a wiper blade according to one embodiment of the present invention.

FIG. 6 illustrates a front view of the wiper blade according to one embodiment of the present invention.

FIG. 7 illustrates a schematically cross-sectional view along section line B-B shown in FIG. 6.

FIG. 8 illustrates a schematically cross-sectional view along section line C-C shown in FIG. 6.

FIG. 9 illustrates a plan view of a first butterfly spring according to one embodiment of the present invention.

FIG. 10 illustrates a contact pressure distribution diagram in the wiper blade according to one embodiment of the present invention.

FIG. 11 is a schematically cross-sectional view along section line B-B of FIG. 6 for further showing air flow surrounding the wiper blade while the motor vehicle runs at high speed.

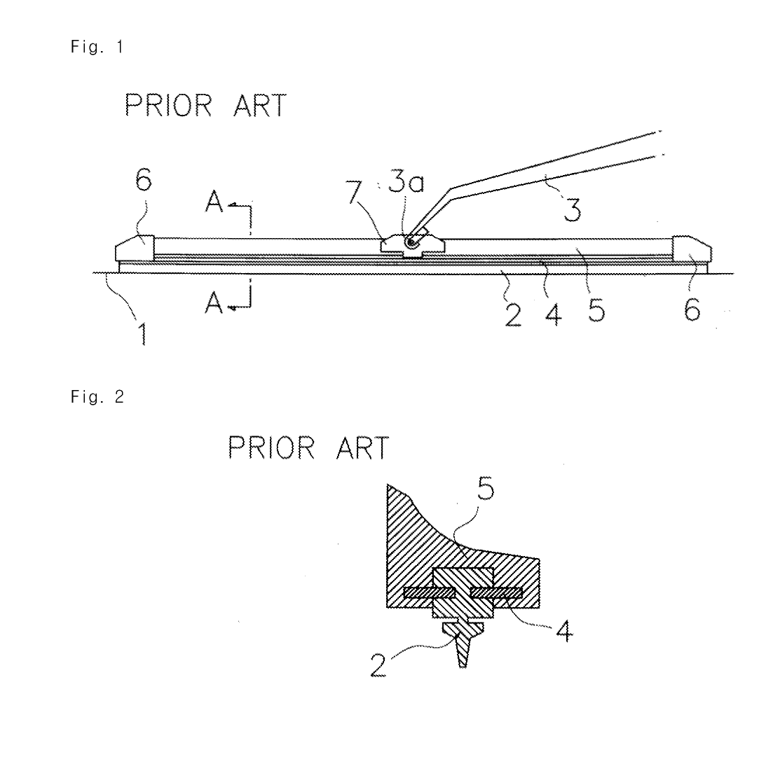

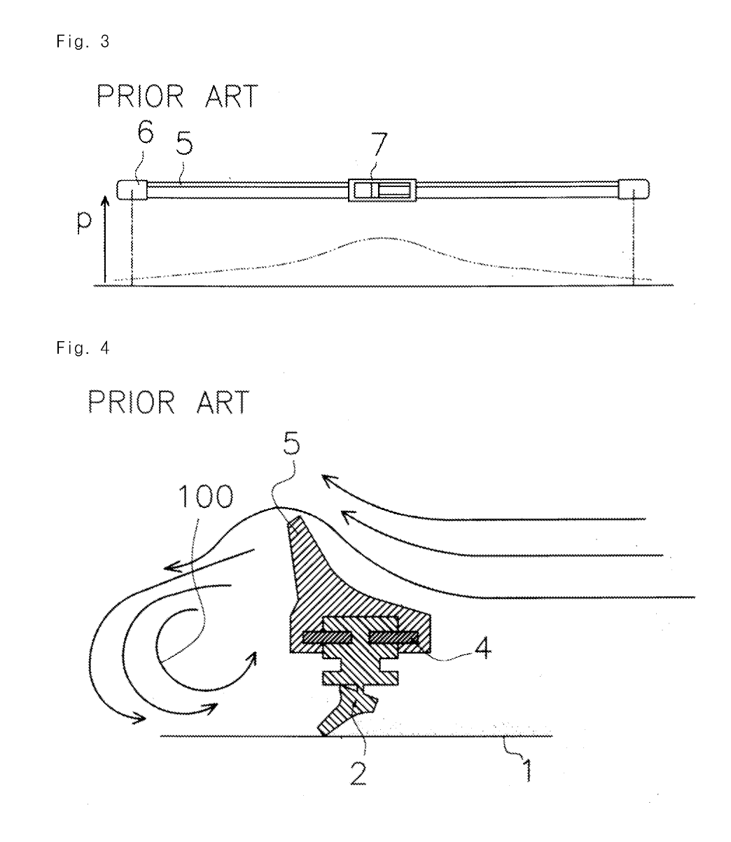

### DETAILED DESCRIPTION OF THE INVENTION

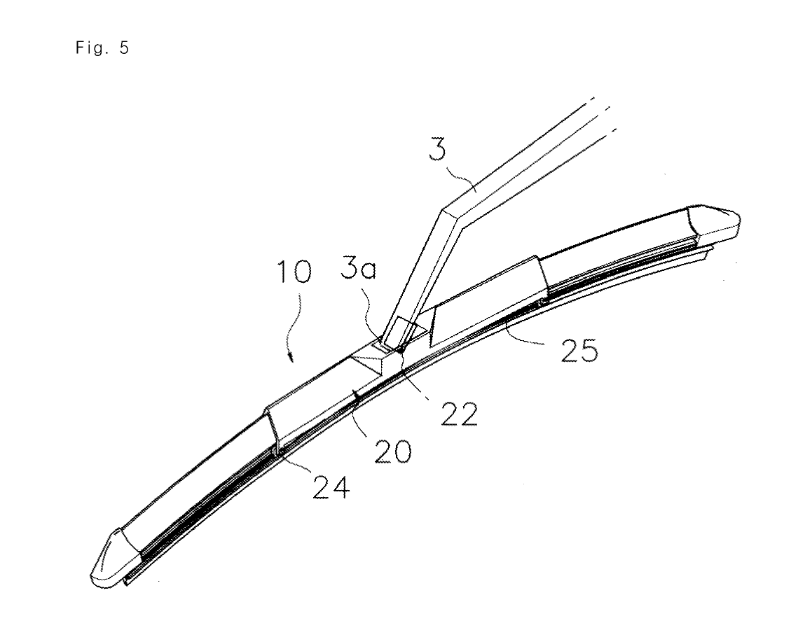

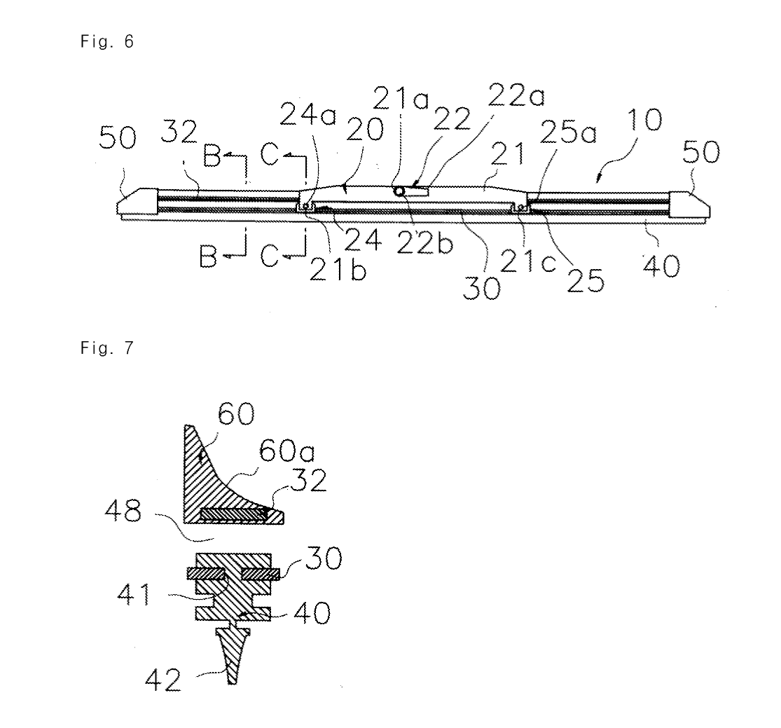

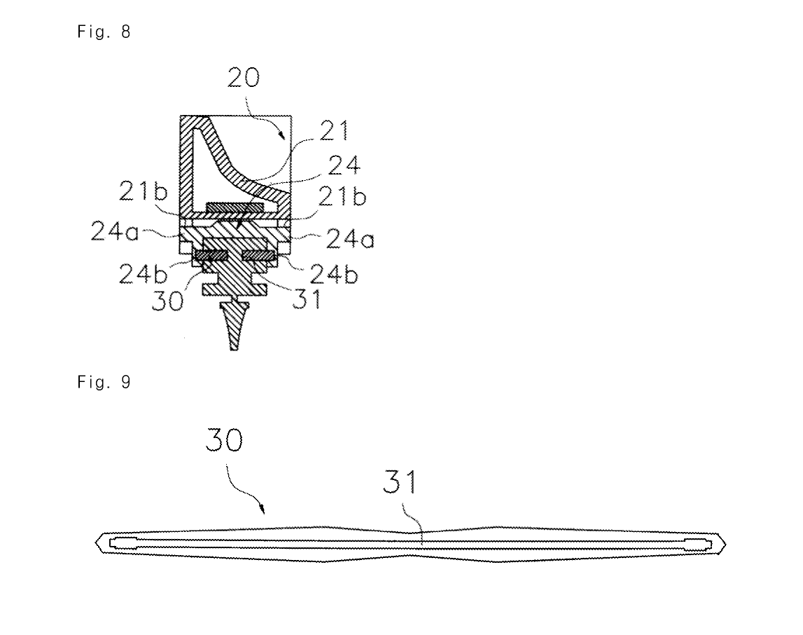

Preferred embodiments of the present invention will be described in detail with reference to FIGS. 5 to 11.

In FIGS. 5 to 9, a wiper blade 10 according to one embodiment of the present invention comprises a primary lever 20 which a clip 22 is rotatably mounted on and has a predetermined length, the clip 22 being fastened to a U-shaped connector 3a of a wiper arm 3; a first butterfly spring 30 which is fastened to a first and second yokes 24 and 25 rotatably mounted on the opposite lower portions of the primary lever 20; a rubber element 40 which is fastened to the first butterfly spring 30 and contacts at the lower end portion with a windshield glass 1 in a motor vehicle; a second butterfly spring 32 which is mounted above the first butterfly spring 30 at a distance from each other to form a constant gap 48 and is supported on the primary lever 20 at the central portion so as to transmit an application force of the wiper arm 3 to opposite end portions of the rubber element 40; an end cap 50 which fixes opposite ends of the first and second butterfly springs 30 and 32 and opposite ends of the rubber element 40; and a spoiler 60 which surrounds the outside of the second butterfly spring 32 to compensate for flotation of the wiper blade 10 by a wind while the motor vehicle runs.

The above-described elements will be explained more concretely in the following.

Said primary lever 20 has a body 21 of a prescribed length and a pair of first holes 21a formed at a central portion of the body 21 in a traverse direction of the body 21. A clip 22 is provided to which an U-shaped connector 3a of a wiper arm 3 is fastened at said first holes 21a of the body 21. Here, the clip 22 has a body 22a and a pair of first hinge pieces 22b rotatably fastened to the first holes 21a at each side of the body 22a.

The primary lever 20 has a pair of second holes 21b and a pair of third holes 21c formed at opposite end portions of a lower end of the body 21 in a traverse direction of the body 21.

A first and second yokes 24 and 25 are rotatably fastened to the second holes 21b and the third holes 21c, respectively.

Here, the first yoke 24 has a pair of second hinge pieces 24a rotatably fastened to the second holes 21b of the primary lever 20 at opposite sides of the first yoke 24, and a pair of first support grooves 24b formed at a lower side of the first yoke 24 in the longitudinal direction. Similarly, the second yoke 25 has a pair of third hinge pieces 25a rotatably fastened to the third holes 21c of the primary lever 20 at opposite sides of the second yoke 25, and a pair of second support grooves not shown formed at a lower side of the second yoke 25 in the longitudinal direction. Although the second support grooves are not shown, it can be understood that the second support grooves are identical with the first support grooves 24b since the first yoke 24 and the second yoke 25 are identical with each other in shape. Thus, the first butterfly spring 30 is slidably inserted into the first support grooves 24b of the first yoke 24 at one side of a center of the first butterfly spring 30, and is slidably inserted into the second support grooves of the second yoke 25 at other side of the center of the first butterfly spring 30.

The first butterfly spring 30 is slidably inserted into such first support grooves 24b of the first yoke 24 and such second support grooves of the second yoke 25. Therefore, the first butterfly spring 30 is movable and rotatable in part at the second hinge pieces 24b of the first yoke 24 and the third hinge pieces 25a of the second yoke 25, thereby being able to be bent.

Here, the first butterfly spring 30 should be naturally fastened to the rubber element 40 before being fastened to the first yoke 24 and the second yoke 25.

Such a first butterfly spring 30 is formed of an elastic material of a prescribed width, and has a curvature and a length for cleaning a desirable zone of the windshield glass 1. Also, the first butterfly spring 30 has a slot 31 along the longitudinal direction of the first butterfly spring 30. The rubber element 40 which contacts the surface of the windshield glass 1 and cleans rainwater or foreign substance is installed to the slot 31.

That is, the rubber element 40 has inserting grooves 41 formed along opposite side walls of a body of the rubber element 40 in the longitudinal direction so as to be inserted into the slot 31 of the first butterfly spring 30. The inside edges of the slot 31 are inserted into the inserting grooves 41, thereby preventing the rubber element 40 from being separated. Also, the rubber element 40 has a sharp contact portion 42 protruded at a lower end of the body of the rubber element 40 along the longitudinal direction, which contacts the surface of the windshield glass 1.

Meanwhile, a second butterfly spring 32 is provided above the first butterfly spring 30 at a distance so as to maintain a constant gap 48. The second butterfly spring 32 is formed of an elastic material with a prescribed width and a prescribed length similar to the first butterfly spring 30, and is fixedly installed to the opposite ends of the primary lever 20.

Here, the second butterfly spring 32 performs a function to transmit an application force of the wiper arm 3 to opposite end portions of the rubber element 40. A spoiler 60 which has an inclined surface 60a is provided to prevent flotation of the wiper blade by a wind while the motor vehicle runs. The inclined surface 60a is formed at an upper side of the second butterfly spring 32, and has a rear side higher than a front side.

Such first and second butterfly springs 30 and 32 are fixed to each other by means of an end cap 50.

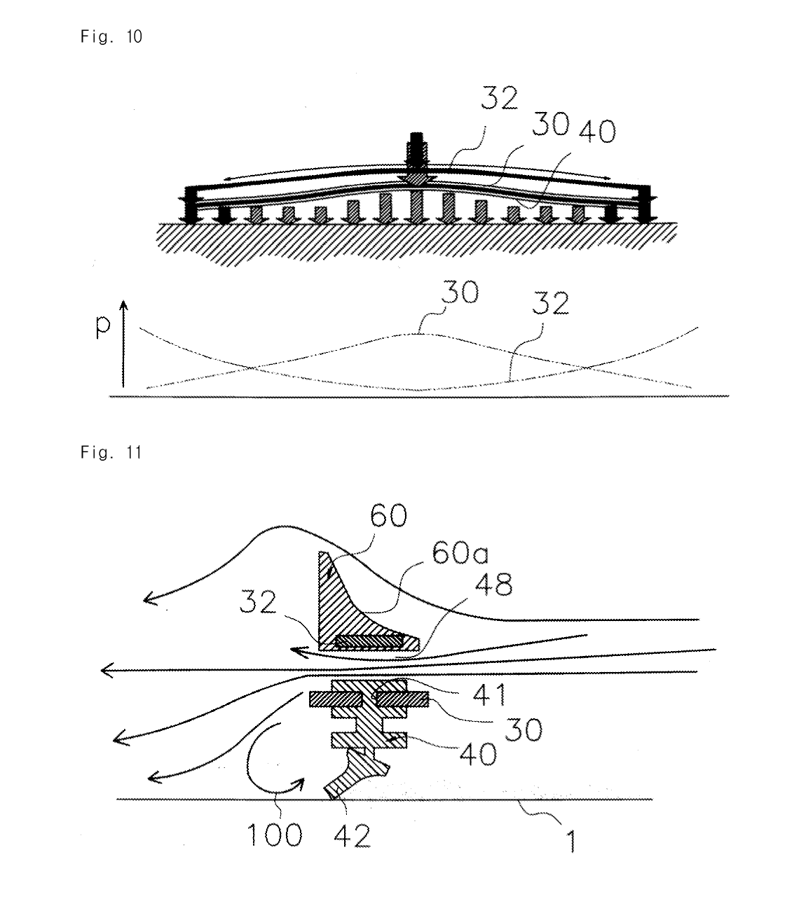

Now, distribution of contact pressures on the surface of the windshield glass 1 by the wiper blade according to the present invention will be described in detail with reference to FIG. 10. In FIG. 10, “p” represents contact pressures.

A force transmitted by the wiper arm 3 is transmitted to the primary lever 20 through the clip 22. The transmitted force is divided into the first butterfly spring 30 and the second butterfly spring 32 according to their elasticity characteristics, the first butterfly spring 30 and the second butterfly spring 32 being arranged at the lower and upper sides on the basis of the surface of the windshield glass 1.

That is, the force applied by the wiper arm 3 is divided into a first route and a second route through the primary lever 20. In the first route, the force is partially transmitted to the central portion of the first butterfly spring 30 through the first and second yokes 24 and 25 which are rotatably supported by the opposite lower portions of the primary lever 20 and which support the first butterfly spring 30. In the second route, the force is partially transmitted to the end cap 50 through the primary lever 20 and the second butterfly spring 32 which is fastened by the primary lever 20 by means of a spoiler 60, etc., thereby pressing the rubber element 40 at the opposite end portions.

That is, the force partially transmitted to the first butterfly spring 30 through the first route is transmitted to the windshield glass 1 as contact pressure in the central portion of the rubber element 40. And, the force partially transmitted to the second butterfly spring 32 through the second route is transmitted to the windshield glass 1 as contact pressure in the opposite end portions of the rubber element 40. Thus, a curvature-trace characteristic of the wiper blade 10 is improved, and more uniform and more increased contact pressures are obtained over the whole length of the wiper blade 10.

Meanwhile, in FIG. 11, a wiper blade according to another embodiment of the present invention is provided with a gap 32 formed between the first butterfly spring 30 and the second butterfly spring 32. Such a gap 32 allows air to flow, thereby minimizing generation of air eddies 100 at the rear side of the wiper blade while the motor vehicle runs at high speed. That is, as generation of air eddies 100 is minimized, the water-drawn phenomenon mentioned above is also minimized, and water-gathering, etc., on the surface of the windshield glass 1 is prevented. Thus, an impediment to a visual range of a driver can be minimized.

Conclusively, as described above, in the wiper blade according to the present invention, the force applied by the wiper arm 3 is divided into the first butterfly spring 30 and the second butterfly spring 32, and then distributed evenly to the central portion and the opposite end portions of the rubber element 40. Thus, the present invention has an advantage that contact pressures in contact with the windshield glass 1 are improved and flotation at the opposite end portions of the rubber element 40 is prevented, thereby improving cleaning characteristic of the windshield glass 1.

Furthermore, by forming a gap 48 between the first butterfly spring 30 and the second butterfly spring 32, the present invention has another advantage that generation of air eddies is minimized and an impediment to a visual range of a driver can be minimized.

Still furthermore, the present invention can satisfy various conditions in inclination or curvature of the windshield glasses of the motor vehicles and increase the contact pressures particularly in the opposite end portions of the wiper blade. Therefore, the present invention has still another advantage that the wiper blade according to the present invention can be used commonly for various curvatures in the windshield glasses of the motor vehicles with an improved inclination-trace characteristic and excellent cleaning quality.

Although the present invention has been explained by the embodiments shown in the drawings described above, the present invention is not limited to the embodiments, but rather that various changes or modifications thereof are possible without departing from the spirit of the present invention. Accordingly, the scope of the present invention shall be determined only by the appended claims and their equivalents.

1. A wiper blade for a motor vehicle comprising:
a primary lever (20) on which a clip (22) is rotatably mounted and which has a predetermined length, the clip (22) being fastened to a connector (3a) of a wiper arm (3) of the motor vehicle;
a first butterfly spring (30) which is mounted on a lower portion of the primary lever (20) and has a predetermined length;
a rubber element (40) which is fastened to the first butterfly spring (30) and contacts at the lower end portion with a windshield glass (1) in the motor vehicle;
a second butterfly spring (32) which is mounted above the first butterfly spring (30) at a distance and is supported by the primary lever (20) at the central portion so as to transmit an application force of the wiper arm (3) to opposite end portions of the rubber element (40); and
an end cap (50) which fixes opposite ends of the first and second butterfly springs (30, 32) and opposite ends of the rubber element (40) together.

2. A wiper blade according to claim 1, further comprising a spoiler (60) which has an inclined surface (60a), the inclined surface (60a) having a rear side higher than a front side at an upper side of the second butterfly spring (32) so as to prevent flotation of the wiper blade by a wind while the motor vehicle runs.

3. A wiper blade according to claim 1, wherein the second butterfly spring (32) is spaced with the first butterfly spring (30) at a distance and a gap (48) for flowing air is formed between the first butterfly spring (30) and the second butterfly spring (32).

4. A wiper blade according to claim 1, wherein the first butterfly spring (30) is formed of an elastic material with a curvature and a length for cleaning a desirable zone of the windshield glass (1) and has a slot (31) for mounting the rubber element (40) along the longitudinal direction of the first butterfly spring (30).

5. A wiper blade according to claim 1:
wherein the primary lever (20) has a body (21) of a predetermined length, a pair of first holes (21a) formed at a central portion of the body (21) in a traverse direction of the body (21), and each pair of second and third holes (21b and 21c) formed at opposite end portions of the body (21) in a traverse direction of the body (21);
wherein the clip (22) has a body (22a) and a pair of first hinge pieces (22b) rotatably fastened to the first holes (21a) at each side of the body (22a); and
wherein a first and second yokes (24 and 25) are rotatably fastened to the second holes (21b) and the third holes (21c) with supporting the first butterfly spring (30).
